(19) United States
(12) Patent Application Publication
(10) Pub. No.: US 2004/0146657 A1
(43) Pub. Date: Jul. 29, 2004

(54) Method for plasma coating a turbine blade and coating device

(76) Inventors: Claus Heuser, Alzenau (DE); Gerhard Johner, Gelnhausen (DE); Helge Reymann, Berlin (DE)

Correspondence Address: HARNESS, DICKEY & PIERCE, P.L.C., P.O.BOX 8910, RESTON, VA, 20195, US

(21) Appl. No.: 10/467,939

(22) PCT Filed: Feb. 13, 2002
(86) PCT No.: PCT/EP02/01515

(30) Foreign Application Priority Data
Feb. 14, 2001 (EP) 011034576

(51) Int. Cl. B05D 1/08; B05C 5/00

(52) U.S. Cl. 427/446; 118/300

(57) ABSTRACT

The invention relates to a method for plasma coating a turbine blade (11), wherein at least three plasma torches (19, 21, 23) are used simultaneously with the aim of achieving a particularly high-quality coating (81), especially of McrAlX on a base body (30) made of a nickel or cobalt-based superalloy. The invention also relates to a coating device (1) to implement said method.

The invention relates to a process for the plasma coating of a turbine blade or vane which is oriented along a blade or vane axis by means of thermal plasma spraying. The invention also relates to a coating device for carrying out the process.

A coating process for the plasma coating of a turbine blade or vane is disclosed in EP 1 033 417 A1. One of the possible coatings to be applied to the turbine blade or vane consists of an MCrALX alloy, where M represents one or more elements selected from the group consisting of iron, cobalt or nickel, Cr represents chromium, Al represents aluminum and X represents one or more elements selected from the group consisting of yttrium, rhenium and the rare earth elements. This metallic layer is applied to the turbine blade or vane by thermal spraying using the VPS (vacuum plasma spraying) or LPPS (low pressure plasma spraying) process. The gas turbine blade or vane consists in particular of a nickel- or iron- or cobalt-base superalloy. The MCrALX alloy is used in particular to prevent corrosion and oxidation. However, it is often also used as a bonding layer between a ceramic thermal barrier coating and the base material. The application of a layer is generally followed by a further heat treatment. A process time of approximately 30 minutes typically results for the application of an MCrALX layer using the VPS or LPPS process, while the further thermal treatment of the gas turbine blade or vane has a process time of approximately 120 minutes. The plasma coating is carried out using a plasma gun or a plasma torch. A plasma torch of this type is often also used to heat the component which is to be coated prior to the coating operation. The turbine blade or vane which is to be coated is normally arranged on a turntable, while the plasma torch is arranged on a multiaxis robot. During the coating, the turbine blade or vane is held at a coating temperature of approximately 1100° K. to 1200° K.

It is an object of the invention to provide a process for the plasma coating of a turbine blade or vane which in particular leads to an improved quality of the coating applied by thermal plasma spraying. A further object of the invention is to provide a coating device for carrying out the process.

According to the invention, the object relating to a process is achieved by the provision of a process for the plasma coating of a turbine blade or vane which is oriented along a blade or vane axis, in which at least three plasma torches for thermal plasma spraying are used simultaneously.

The invention is based on the discovery that the conventional use of a single plasma torch leads to certain losses in quality for the coating of the turbine blade or vane. In particular, an undesirably high layer thickness is produced on certain critical areas, such as the transition region between the main blade section and adjoining blade platforms, since the coating of the platform, on the one hand, and of the main blade part, on the other hand, lead to an overlap in the boundary region which cannot be avoided with known coating methods and therefore to an increased layer thickness. Furthermore, in the case of coating by means of only one torch, pores are formed in the coating, on account of the spraying angle being too shallow. Pore formation of this type leads to increased corrosion of the base material which is actually to be protected by the coating. Furthermore, the invention has discovered that, in the case of coating with just one torch, the temperature profile is unfavorable for the component which is to be coated, since the component cannot be heated sufficiently uniformly using just one torch.

The outlay involved in using at least three plasma torches, which would at first glance be considered unacceptably high, is a suitable way of avoiding these drawbacks. Furthermore, the use of at least three torches also offers the option of coating particularly large turbine blades or vanes, such as for example rotor blades belonging to the last row of rotor blades of a stationary gas turbine, with lengths of greater than 50 cm, with a high-quality coating. Finally, by using at least three torches, it is possible to achieve in particular a more constant layer thickness distribution.

A) It is preferable for one of the torches to be used to heat the turbine blades or vanes. This makes it possible to ensure that the turbine blade or vane is heated to a uniform temperature and is held at such a uniform temperature during the coating operation as well.

B) It is preferable for at least two of the plasma torches to be actuated independently of one another. These plasma torches are therefore decoupled from one another and can be moved independently of one another during the coating operation, allowing the angles of incidence, coating rates, etc. to be optimized in a manner which is suitably matched to all phases of the coating operation. In particular, it is possible to distinguish between the main blade part coating, on the one hand, and the platform coating, on the other hand, in such a way that one or two torches are used for coating of the main blade part while the other torch(es) is/are used for platform coating.

C) It is preferable for the turbine blade or vane to be rotated along the blade or vane axis.

D) Also preferably, a first one of the torches sprays onto the turbine blade or vane in a first spraying direction and is rotated about a first axis of rotation, which is oriented perpendicular to this first spraying direction and lies in a plane encompassed by this first spraying direction and the blade or vane axis. In this structurally simple embodiment, therefore, only the angle at which the first torch sprays onto the turbine blade or vane is changed. This change in angle is effected by rotation about the first axis of rotation.

E) Also preferably, a second one of the torches sprays onto the turbine blade or vane in a second spraying direction and is rotated about a second axis of rotation, which is oriented perpendicular to this second spraying direction and lies in a plane encompassed by this second spraying direction and the blade or vane axis, the first spraying direction and the second spraying direction including an angle >90° with one another. Therefore, the second torch can likewise simply be rotated about the axis of rotation, in a manner which is very simple in design terms, so that its spraying angle can be altered. The two torches in this case form an obtuse angle with respect to one another, so that these two torches can be used particularly successfully to carry out either only a coating of the main blade part or only a coating of the platform. During the platform coating by these two torches, each torch is assigned one platform. In the case of a rotor blade, a platform of this type arranged at the blade tip is also known as a cover strip.

F) It is preferable for the first and second torches to be displaced jointly along the blade or vane axis. This may furthermore preferably be effected by a chain or belt drive which lies in particular outside the coating chamber and to which the torches are secured in such a way that they are displaced jointly along the blade or vane axis so as to follow a movement of the chain or belt.

G) Preferably, a third one of the torches sprays onto the turbine blade or vane in a third spraying direction and is rotated about a third axis of rotation, which lies in a plane encompassed by this third spraying direction and the blade or vane axis. Therefore, the third torch too is designed such that it can be rotated only about the third axis of rotation in a manner which is simple in design terms.

H) The third axis of rotation preferably lies either parallel to the blade or vane axis or perpendicular to the blade or vane axis.

I) It is preferable for the third torch to be moved in a direction which is perpendicular to the plane.

J) It is preferable for the third torch to be moved along the third spraying direction.

K) The third torch is preferably moved parallel to the blade or vane axis.

Although the additional movement options for the third torch result in a solution which is more complex in design terms, they have the advantage in particular that less coating powder has to be sprayed past the turbine blade or vane during plasma spraying than is the case with torches whose distance from the turbine blade or vane cannot be altered.

L) The process is preferably carried out under a vacuum. This may be a vacuum plasma spraying (VPS) process at approx. 10⁻⁴ to 10⁻⁶ mbar. In particular, however, a process at approx. 10⁻¹ to 10⁻² mbar is suitable (low pressure plasma spraying, LPPS).

M) The process is preferably used for the plasma coating of a base material made from a nickel- or cobalt-based superalloy, in which an MCrALX protective layer, as described in the introduction, is applied to the base body.

The object relating to a coating device is achieved, in accordance with the invention, by the provision of a coating device for coating a turbine blade or vane by means of a process in accordance with one of the possible options described above.

The embodiments of points A) to M) can also be combined with one another in any desired way.

The invention is explained in more detail, by way of example, with reference to the drawing, in which, in some cases diagrammatically and not to scale:

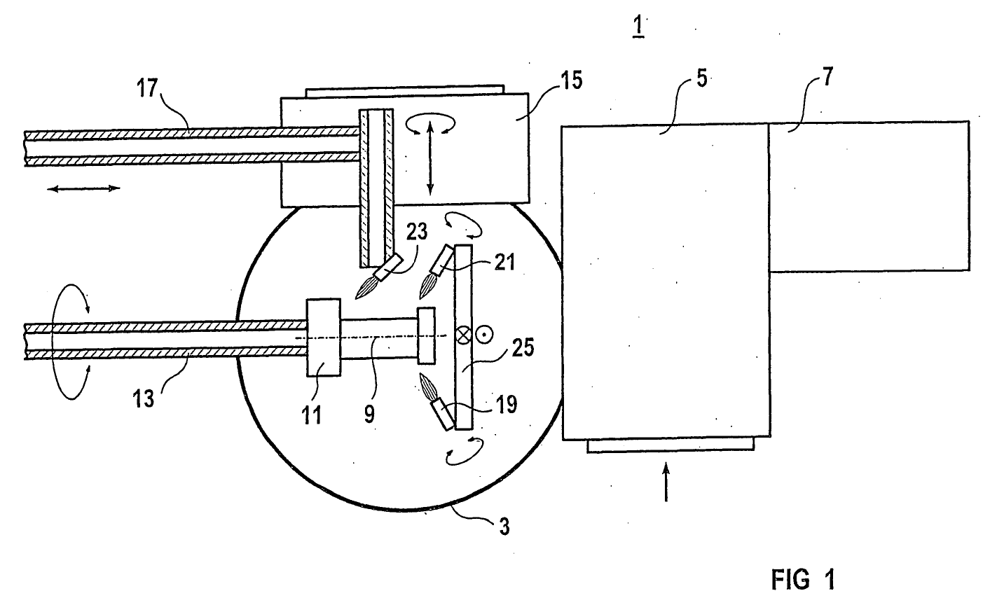

FIG. 1 shows a coating device for thermal plasma spraying,

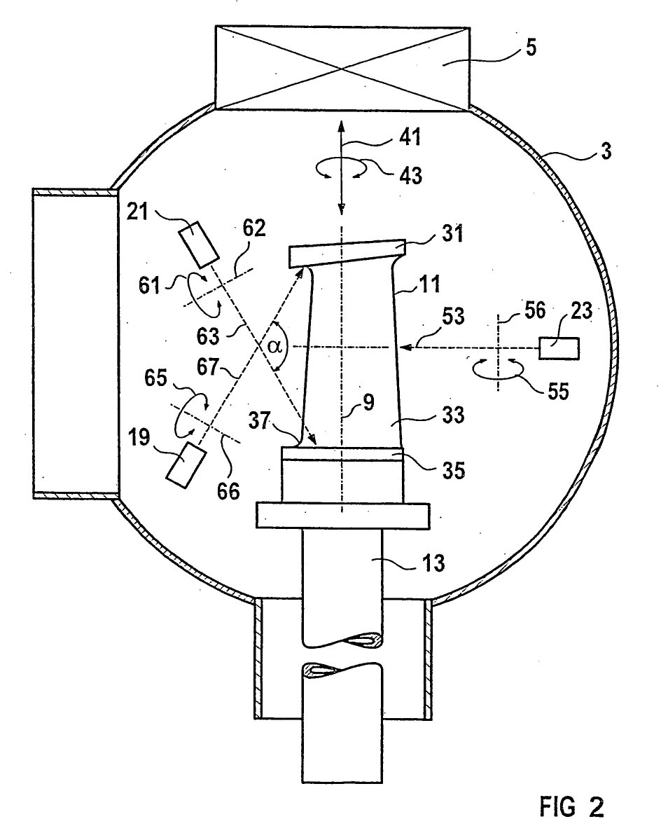

FIGS. 2-4 show processes for coating a turbine blade or vane using three plasma torches, in each case with a different plasma torch mobility.

Identical reference symbols have the same meaning throughout the various figures.

FIG. 1 shows a coating device 1. The coating device 1 has a coating chamber 3. An antechamber 5 is connected in vacuum-tight manner to the coating chamber 3. A turbine blade or vane 11 which is oriented along a blade or vane axis 9 is arranged in the coating chamber 3. The turbine blade or vane 11 is arranged on a blade or vane manipulator 13 which leads into the coating chamber 3. Via an extension chamber 15, which is connected to the coating chamber 3, a torch manipulator 17 likewise leads into the coating chamber 3. A first plasma torch 19 and a second plasma torch 21 are arranged on a torch carrier 25. A third plasma torch 23 is arranged at the torch manipulator 17. The three plasma torches 19, 21, 23 are decoupled from one another and can therefore be actuated and moved independently of one another.

Whereas in the case of a conventional coating process with just one plasma torch, there are quality problems during the coating of the turbine blade or vane 11, the coating by means of three plasma torches 19, 21, 23 achieves particularly high-quality coatings of the turbine blade or vane 11. This relates in particular to a reduction in what is known as overspray, i.e. regions in which an excessively high layer thickness occurs on account of them being sprayed a number of times when just one torch is used. The use of a plurality of torches, and in particular the division of the plasma torches 19 and 21 for coating the main blade part of the turbine blade or vane 11, on the one hand, and the use of the third plasma torch 23 for coating of the platforms of the turbine blade or vane 11 greatly reduces this overspray. Furthermore, particularly in the case of especially large turbine blades or vanes, one of the plasma torches 19, 21, 23 can be used to heat the turbine blade or vane 11, resulting in a targeted introduction of heat precisely where it is required, which in turn results in an improvement in quality of the layer. In the case of particularly large turbine blades or vanes, for example of the order of magnitude of a length of 1 m, coating with a sufficiently high quality is only made possible, for the first time, by the use of at least three plasma torches 19, 21, 23. Ultimately, the use of the three plasma torches 19, 21, 23 also leads to a layer thickness distribution on the turbine blade or vane 11 which is more constant overall.

FIG. 2 shows a particularly simple design for the installation of the three plasma torches 19, 21, 23. The turbine blade or vane 11 is therefore a gas turbine blade or vane made from a nickel- or cobalt-base superalloy base material 30. It has a main blade part 33, which is adjoined at its tip by a tip platform 31 and on its root side by a root platform 35. Rounded regions 37, in which overspray is particularly likely when just one plasma torch is used, as described above, results between the platforms 31, 35 and the main blade part 33. The turbine blade or vane 11 is secured to the blade or vane manipulator 13 in such a way that it can be rotated about the blade or vane axis 9 in a direction of rotation 43 by means of the blade or vane manipulator 13. Moreover, it can be axially displaced along the blade or vane axis 9 in an axial direction 41. A first plasma torch 19 sprays onto the turbine blade or vane 11 along a first spraying direction 67. The first plasma torch 19 can rotate in the direction of rotation 65 about a first axis of rotation 66. A second plasma torch 21 sprays onto the turbine blade or vane 11 along a second spraying direction 63. The second plasma torch 21 can rotate along a second axis of rotation 62 in a direction of rotation 61. The first plasma torch 19 is arranged along a direction which is parallel to the blade or vane axis 9 in the root region of the turbine blade or vane 11, while the second plasma torch 21 is arranged along this direction at the height of the tip of the turbine blade or vane 11. The first spraying direction 67 forms an angle α which is greater than 90° with the second spraying direction 63. In this configuration, the first plasma torch 19 is used to coat the tip platform 31, while the second plasma torch 21 is used to coat the root platform 35.

A third plasma torch 23 is arranged approximately at the height of the intersection between the first spraying direction 67 and the second spraying direction 63, on the opposite side of the turbine blade or vane 11. This third plasma torch 23 sprays onto the turbine blade or vane 11 along a third spraying direction 53. The third plasma torch 23 can rotate along an axis of rotation 56 in the direction of rotation 55.

Prior to the coating of the turbine blade or vane 11 with a coating 81 consisting of a coating material, preferably an MCrALX oxidation/corrosion-resistant layer, the turbine blade or vane 11 is heated. This is effected particularly uniformly by using all three plasma torches 19, 21, 23 simultaneously. After the desired temperature has been reached, the coating material is applied, with the first plasma torch 19 and the second plasma torch 21, as described, being used to coat the platforms 31, 35, while the third plasma torch 23 is used to coat the main blade part 33.

The blade or vane manipulator 13 can move along the axial direction 41, and it is possible for the torch manipulator 17 to move synchronously with respect thereto, so that the torch 23 is always coating the same radius on the turbine blade or vane 11. The torches 19, 21 are decoupled from this synchronous movement.

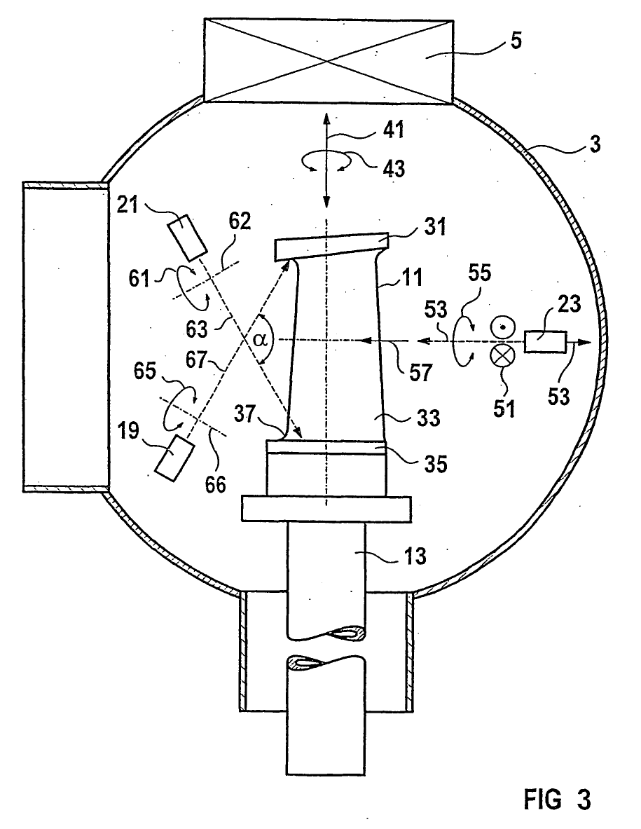

FIG. 3 shows a modification to the coating device 1 shown in FIG. 2, this modification relating to the third plasma torch 23. The latter can now also be moved in a direction 51 which is perpendicular to the plane E defined by the blade or vane axis 9 and the third spraying direction 53. Furthermore, the third plasma torch 23 is also arranged in such a manner that its distance from the turbine blade or vane 11 can also be moved, by means of a feature of mobility along the third spraying direction 53. While in the arrangement shown in FIG. 2 the axis of rotation 56 of the third plasma torch 23 was oriented parallel to the blade or vane axis 9, it is now oriented along the spraying direction 53 and therefore perpendicular to the blade or vane axis 9. The axis of rotation 56 lies in the plane E. As was also the case in FIG. 2, the axes of rotation 56 and 62 of the first plasma torch 19 and of the second plasma torch 21 also lie in the plane E, which is also simultaneously encompassed by the first spraying direction 67 with the blade or vane axis 9 and the second spraying direction 63 with the blade or vane axis 9.

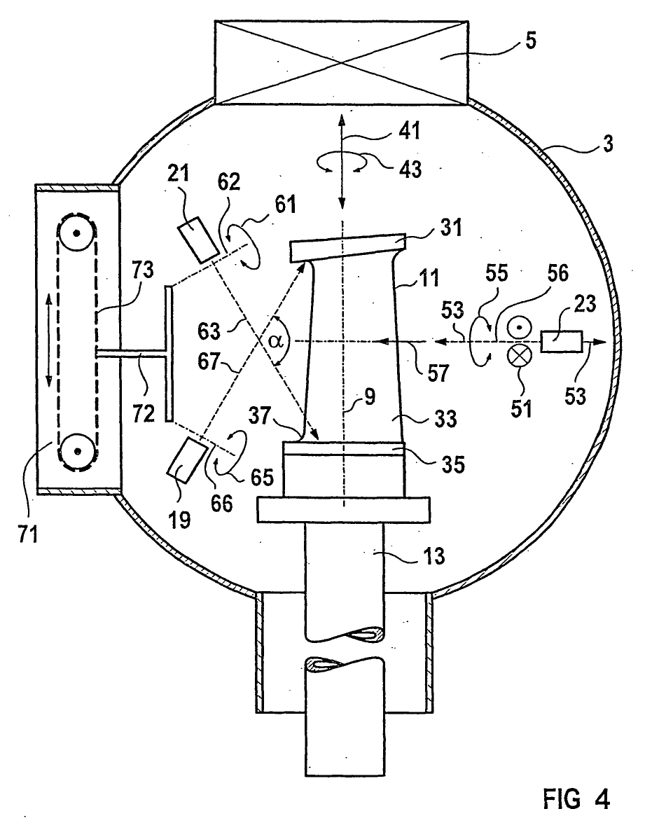

As a further modification, FIG. 4 shows the option of joint mobility of the first plasma torch 19 and the second plasma torch 21 by means of a drive unit 71 which moves a carrier 72 for the first and second plasma torches 19, 21 parallel to the blade or vane axis 9. For this purpose, a chain 73 is moved parallel to the blade or vane axis 9.

1. A process for the plasma coating of a turbine blade or vane (11) which is oriented along a blade or vane axis (9), in which at least three plasma torches (19, 21, 23) for thermal plasma spraying are used simultaneously.

2. The process as claimed in claim 1, in which one of the plasma torches (19, 21, 23) is used to heat the turbine blade or vane (11).

3. The process as claimed in claim 1, in which at least two of the plasma torches (19, 21, 23) are actuated independently of one another.

4. The process as claimed in claim 1, in which the turbine blade or vane (11) is rotated along the blade or vane axis (9).

5. The process as claimed in claim 4, in which a first one of the torches (19) sprays onto the turbine blade or vane (11) in a first spraying direction (67) and is rotated about a first axis of rotation (66), which is oriented perpendicular to this first spraying direction (57) and lies in a plane (E) encompassed by this first spraying direction (67) and the blade or vane axis (9).

6. The process as claimed in claim 5, in which a second one of the torches (21) sprays onto the turbine blade or vane (11) in a second spraying direction (63) and is rotated about a second axis of rotation (62), which is oriented perpendicular to this second spraying direction (63) and lies in a plane (E) encompassed by this second spraying direction (63) and the blade or vane axis (9), the first spraying direction (67) and the second spraying direction (63) including an angle (α) of greater than 90° with one another.

7. The process as claimed in claim 6, in which the first torch (19) and the second torch (21) are displaced jointly along the blade or vane axis (9).

8. The process as claimed in claim 1, in which a third one of the torches (23) sprays onto the turbine blade or vane (11) in a third spraying direction (53) and is rotated about a third axis of rotation (56), which lies in a plane (E) encompassed by this third spraying direction (53) and the blade or vane axis (9).

9. The process as claimed in claim 8, in which the third axis of rotation (56) lies parallel to the blade or vane axis (9).

10. The process as claimed in claim 8, in which the third axis of rotation (56) lies perpendicular to the blade or vane axis (9).

11. The process as claimed in claim 8, in which the third torch (23) is moved in a direction (51) which is perpendicular to the plane (E).

12. The process as claimed in claim 8, in which the third torch (23) is moved along the third spraying direction (53).

13. The process as claimed in claim 8, in which the third torch (23) is moved parallel to the blade or vane axis (9).

14. The process as claimed in claim 1, which is carried out under a vacuum.

15. The process as claimed in claim 1, in which the plasma coating is used to apply a corrosion- and oxidation-resistant layer (81) of MCrALX to a base body (30), consisting of a nickel- or cobalt-base alloy, of the turbine blade or vane (11).

16. A coating device (1) for coating a turbine blade or vane (11) by means of the process as claimed in one of the preceding claims.
